(19) United States
(12) Patent Application Publication
(10) Pub. No.: US 2016/0261764 A1
(43) Pub. Date: Sep. 8, 2016

(54) Student Artwork Compilation

(71) Applicant: Anita Morais, Alameda, CA (US)

(72) Inventor: Anita Morais, Alameda, CA (US)

(21) Appl. No.: 15/059,660

(22) Filed: Mar. 3, 2016

Related U.S. Application Data
(60) Provisional application No. 62/127,567, filed on Mar. 3, 2015.

(51) Int. Cl. H04N 1/21; H04N 1/00; G09B 5/00

(52) U.S. Cl. CPC H04N 1/2179; G09B 5/00; H04N 1/00328; H04N 1/00334; H04N 1/00331; H04N 1/00336; H04N 1/00188; H04N 1/0019; H04N 1/00161

(57) ABSTRACT

Systems and methods of preserving images of student artworks. Labeled artworks are scanned and labels read. Archived images are characterized for content and searched for desired characteristics. Images can be imprinted onto products as keepsakes.

### FIELD OF THE INVENTION

Methods and systems are described for preserving and allowing efficient access to accumulated artworks. Artworks are given unique identification labels to associate particular artworks with particular artists. The art is scanned to provide digital images and the labels are read to associate the artist with the art. Images can be reviewed using image recognition hardware to characterize the content. Systems include label generation, scanning, reading, and image review hardware to store and retrieve art images of interest.

### BACKGROUND OF THE INVENTION

Students and artists generate large amounts of artworks, much of which is poorly documented and lost. Artworks generated at public and parochial schools are often lost and never reviewed for value. We believe that one reason for this problem is that the amount and physical volume of generated artworks makes it difficult to store and review. In addition, many artworks have an awkward shape or size and are not amenable to standard filing systems.

It is notable that certain on-line merchants do offer any number of consumer products imprinted with photo images provided by customers. In Berger (U.S. 8,065,196) methods are described, e.g., to import personalization data from retain customers for incorporation into stationery products. In this way letterhead can be designed and ordered to include personal photos of the customer. This technology does nothing to organize or characterize the image subject matter of the customer.

A need exists for a system to archive the artworks children generate in school. We believe it would be desirable to have systems and methods to memorialize and organize the abundant artworks of children in school. We foresee benefits could also be realized to schools through sales of merchandise imprinted with the personal art of students, or the highest quality art compiled for the school. The present invention provides these and other features that will be apparent upon review of the following.

### SUMMARY OF THE INVENTION

The present inventions include, e.g., systems and methods for archiving, characterizing, searching, and producing student artwork merchandise.

In the methods, student's artwork histories can be preserved by preparing a roster of students, preparing unique student identification labels for each student, attaching one or more of the identification labels for each student to one or more artworks created by the respective student, digitally scanning an image of the artworks, reading the identification label attached to the artwork, and associating the student identification readout with the image of the student's artwork. The images can be searched to identify those associated with a characteristic of interest and presented for viewing or printing.

The artwork can be any capable of scanning to a file, e.g., a sketch, a painting, a collage, a mosaic, a statue, and jewelry.

Attaching the labels can be done by any appropriate technique, such as, e.g., applying a label with a pressure sensitive adhesive or tying on a tag. Optionally, a student identification label can comprise a student fingerprint or other biometric.

Scanning the artwork can be done by any appropriate technique, such as, e.g., digital photography, scanning with a flatbed scanner, 3D imaging, laser scanning, and/or the like.

Reading the identification label can be carried out as appropriate for the particular label. For example, reading can be by reading a bar code, identifying a fingerprint, character recognition, RFID detection, and/or the like.

The image can be associated with information useful in characterizing the subject matter. For example, the artwork image can be associated with student artist identification, e.g., by inserting the student identification into metadata of the image.

The images can be archived, e.g., separately in files, or separately searchable for each student, and/or by other parameters. The image files can be associated with identifiable characteristics, e.g., using metadata identifying a property of the image, such as a color in the image, a date, a person, an animal, a place, a holiday, and/or the like. The characteristics can be recognized and input manually by a person, or optionally identified by image recognition software.

Images can be selected, e.g., based on a viewed image or by searching the archive for desired characteristics. A selected image can be printed onto a selected product, such as, e.g., a photo print, a cup, a book, a shirt, a pillow, a calendar, a trophy, sporting equipment, and/or the like.

The present inventions include systems for retaining, searching and using artworks. The systems can include elements that physically interact to provide useful and transformed products. For example, the system can include a roster of two or more art students, a set of labels for each of the two or more students (each set of labels identifying one of the two or more students), a scanner adapted to generate a digital image of artworks created by the two or more students, and a reader adapted to read a student identification label. The artworks created by one of the students can be labeled with the student's identification label, scanned with the scanner to generate the digital image, and the label read by reader provide artwork identification for association of the student identification with the digital image. An image processing device can be provided to identify characteristics of interest in images generated by the scanner, e.g., so that the characteristics can be associated with the images to facilitate searches for images with subject matter desired by users.

### DEFINITIONS

Before describing the present invention in detail, it is to be understood that this invention is not limited to particular devices or systems, which can, of course, vary. It is also to be understood that the terminology used herein is for the purpose of describing particular embodiments only, and is not intended to be limiting. As used in this specification and the appended claims, the singular forms “a”, “an” and “the” include plural referents unless the content clearly dictates otherwise. Thus, for example, reference to “a surface” includes a combination of two or more surfaces; reference to “product” includes mixtures of products, and the like.

Unless defined otherwise, all technical and scientific terms used herein have the same meaning as commonly understood by one of ordinary skill in the art to which the invention pertains. Although any methods and materials similar or equivalent to those described herein can be practiced without undue experimentation based on the present disclosure, preferred materials and methods are described herein. In describing and claiming the present invention, the following terminology will be used in accordance with the definitions set out below.

A roster is a listing of members in the same class. For example, a roster can be a primary list of persons (e.g., artists) engaging in the same type of productive activity (e.g., art students with the same teacher). The roster can include further information associated with the primary listing (as in a spreadsheet).

Labels are attachable or applied indicia or signals that can be physically associated with an object to provide information of interest (e.g., an identity or ownership), as is commonly understood. Labels in the present inventions are typically imprinted media (e.g., paper stickers or tags) for attachment to the artwork in order to identify the artist. Alternately, labels can be imprints directly in or on an artwork surface

Artworks are typically ornamental creative works prepared by an artist. For example, artworks can include paintings, sculptures, photographs, drawings, etc., as is commonly understood.

A digital image is a digital file encoding features of a scene, image, or object. For example, a digital image is a numeric representation (normally binary) of a two-dimensional image, or optionally of a 3D surface. Typically, digital images are rastered images or bitmapped images.

A scanner in the context of the present inventions is a device that can create a digital image. For example, a scanner can be a camera, a copier, handheld scanner, a 3D scanner, a laser scanner, and/or the like.

As used herein, a digital image (file) is “associated” with a label readout when the information read from the label is incorporated with the image file or into the image file, e.g., as meta data, or, e.g., ensconced within the image data.

As used herein image recognition is a function of characterizing features of an image. For example, image recognition can include review of an image to identify a face, a color, text, an object, a pattern, an animal, a drawing, a cartoon, a logo, and/or a visual feature, e.g., as would be perceived by a human viewer. Image recognition can also include recognition of features not perceived by a human viewer, e.g., subliminal images and camouflaged features in the image.

### BRIEF DESCRIPTION OF THE DRAWINGS

FIG. 1 is a block flow diagram of an exemplary method of manipulating, archiving, and utilizing artwork images created by artists.

FIG. 2 is a schematic diagram of a system of components interacting to retain, associate, and utilize artwork images.

FIG. 3 is an exemplary sequence of methods using system components to organize and employ student artworks.

### DETAILED DESCRIPTION

The methods and systems allow the artworks of students to be preserved and searched in digital form. Systems can include components to facilitate identification and retrieval of particular artworks of particular students, e.g., a student listing, student ID labels, scanners to capture artwork images, readers to read labels, and an image processor to classify characteristics of the captured images. The methods can include the steps of listing enrolled students, providing student identity labels, attaching the labels to artworks, reading the labels on the artworks, and capturing the artwork image.

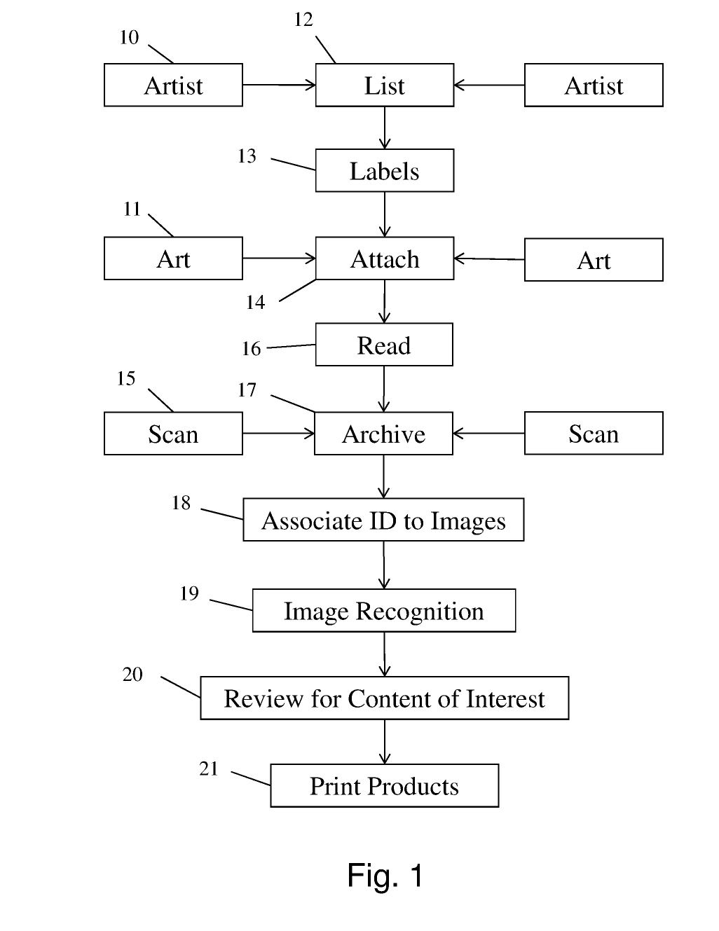

Methods of the invention include, e.g., preserving and characterizing student artist 10 artworks 11, as shown in FIG. 1. A list 12 of students is prepared and labels 13 are generated to physically identify (attach labels 14) artworks as they are created. Labeled artworks are scanned 15 to generate a digital image file, and the identification file is read 16 and stored in the metadata (associated 18) of the scanned image in archive 17. Stored images can be reviewed by image recognition 19 software to further characterize the image, e.g., with image characteristics further added to the image metadata. End users can search 20 the image archive for images having characteristics of interest. Images of interest can be printed 21 onto consumer products.

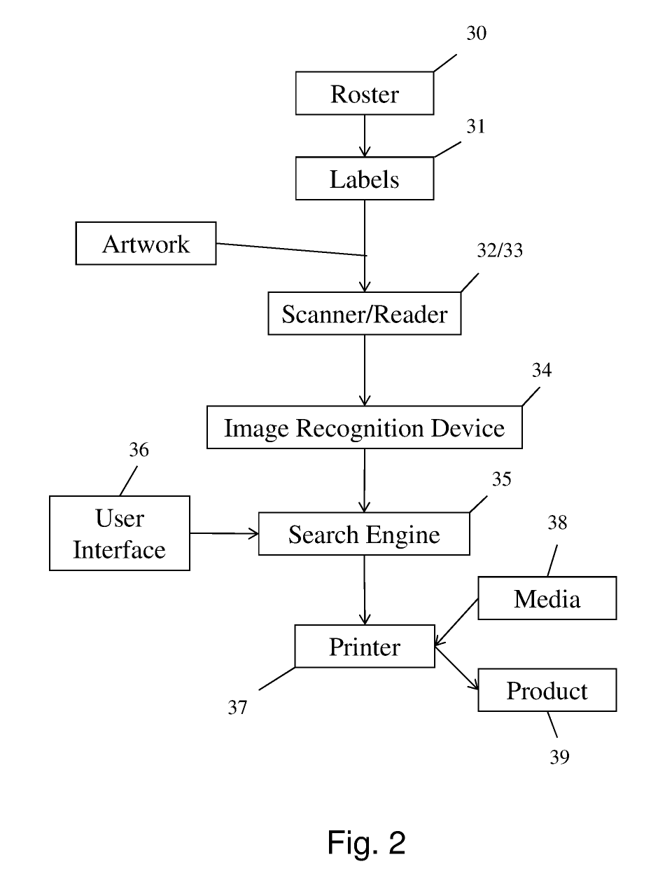

Systems of the invention can be used to capture, identify, search, and express the student's artworks. For example, as shown in FIG. 2, a roster 30 of art students is used to prepare labels 31 to physically identify artworks as they are created. A scanner 32 captures an image of the artwork and a reader 33 captures the artist identity from the label for association with the image. Image recognition devices 34 can identify characteristics of interest in the images and add the information to image metadata. Images with desired characteristics can be found using a search engine 35. Images selected, e.g., through a user interface 36 can be sent to a printer 37 to be imprinted onto a variety of media 38 to provide a product 39.

Methods of Preserving and Accessing Student Artwork Histories. As discussed above, the present methods can include a series of physical steps manipulating and transforming artworks to a searchable compilation and also products, such as merchandise imprinted with personal images. Typically, children's artworks are tagged with an identification label and photographed. During the photography, or in a separate label reading step, the ID label is read and the information attached to the digital photographic image. The image can be analyzed by image recognition systems according to search criteria cataloging characteristics of the image. Child artist's parents can search the images, according to criteria of interest and select desirable images to be archived, printed, or applied to a consumer product.

A roster of artists can prepared, e.g., by listing students in a spread sheet with associated information. The roster can accumulate information on each student, and optionally also provide information on individual artworks.

Preparing labels can include storing information on a physical label. Typically, the information includes at least the name of the student creating artworks. The information can be alpha numeric, or any type of machine readable symbols or indicia. For example, preparing labels can include printing sheets of labels presenting the student's name, a bar code, a fingerprint, and/or other biometric data. Optionally, preparing labels can include incorporation of a radio frequency identification (RFID) tag, of similar remotely readable device, into the label.

Technique for attaching labels can vary according to the nature of the label and artwork. The label could simply be an ink imprint directly on the artwork, or impression into an art media. More typically, the technique for attaching labels includes physical attachment of a label, such as a stamp, tag, stickers, and/or the like. Labeling can include attaching the label with a permanent or removable adhesive. Alternately, the label can be a tag that is tied, hooked, hook and loop, or pinned to the artwork.

Scanning an image of an artwork includes generation of a digital representation of the artwork. For example, scanning an artwork can include scanning a drawing (or other flat artwork) with a flatbed scanner, handheld scanner, digital camera, video camera, and/or the like. With regard to three dimensional artworks, 3D images can be captured, e.g., using a laser scanner, stereo camera and/or the like. The resultant “images” can be physical representations of the artworks, but preferably digital image files, e.g., stored on permanent or volatile media such as ram, cd, dvd, thumb drive, blueray, magnetic tape, floppy disk, hard drive, m-disc, and/or the like. The images can be scanned into separate file folders per artist student. Alternately, the files can include metadata whereby files scanned from many students and many artworks can be searched according to desired parameters, such as artist name, class, type of artwork, date, subject matter, and/or the like.

Labels are read to obtain information to be associated with the scanned image. In one aspect, the labels, attached to the artwork, can be captured in the scanning step. That is, the same device scanning to create the image file of the artwork can also capture an image of the label. Alternately, a separate reader can be employed to read the labels. The reading of labels identifying an artwork can take place before, during, or after scanning of the artwork image.

Various types of information can be associated with the scanned image file. One key type is artist identification. The image file and file holding the information read from the label are typically combined, e.g., so that the image file is “labeled” with the label information in a fashion similar to the attachment of the label to the physical artwork. Typically the label readout and artwork scan files are combined, e.g., with the label read information attached to the image file as metadata. As discussed herein, additional information can be associated with the image file, e.g., keyed information, scanned information, information from readers, and information made available from image recognition of the file or image evaluation (color, occult data, subject matter, location, etc.).

The compiled or archived images can be searched to identify subject matter of interest. The images can be stored in a file folder associated with the artist who created the work. In a similar manner, image files can be stored in folders dedicated to images with certain characteristics, such as holidays, nature, science, fun, dates, etc. In a preferred aspect, the individual image files have imbedded information that facilitates searching and sorting of the images. For example, the images can have characteristics of interest associated with the file, e.g., as metadata. Such metafiles can be searched using commonly available file handling or spreadsheet software.

Besides simply reviewing the images on a flat screen, or providing students with a CD of their year's artworks, the images have a variety of additional beneficial uses. For example, the images can be imprinted onto surfaces of products and merchandise of interest to the artist, artist's family, and/or the public at large. Exemplary products can include images printed onto coffee mugs, calendars, pillows, framed prints, smart phone cases, candles, and/or the like.

The methods can include employing the images of artworks in fund raising efforts. For example, the methods and systems of the invention can be provided to educators. At the beginning of the school year, permissions can be obtained from parents and/or students to use the images in fundraising. The school can create a roster of students and generate sticker sheets of identification labels for each student. As artworks are created, students apply the labels to their work, and the artworks are scanned, along with their identification labels. The image files are archived and associated with characteristic information to facilitate searching. At various events during the school year, suitable images are identified for printing as products for sale.

Systems for Preserving and Accessing Student Artwork Histories. Specialized systems can be used to practice the methods of storing and using artworks. System components can be used to generate a roster, label artworks, read and scan artworks, characterize artworks, search artworks, and print artworks.

Systems include a roster of artists participating in the art storage and use system. The roster can be a list of artists on a physical tabulation or a list in a computer file. The roster can include the artist's names. Further, the roster can have associated information, such as the student's teacher, class dates, contact information, and/or the like.

The systems include identification labels to be affixed to artworks as described herein. For example, a printer can be used to print information onto adhesive backed paper labels. The labels can include the artist's name, and optionally additional information from the roster. The labels can include alphanumeric characters readable by persons and/or computer readable information, such as bar codes. The labels can optionally be tags. The labels can optionally be printed onto the artwork itself, e.g., on a bottom or back surface. The labels can emit signals, e.g., from RFID circuits integrated into a label body, or even integrated into the artwork itself.

The scanners of the systems are generically any devices capable of capturing a 2D or 3D image of an artwork. Typical scanners are cameras, digital cameras, movie cameras, handheld scanners, flatbed scanners, laser scanners, 3D scanners, and/or the like.

Label readers are those capable of reading the type of label elected for use in a particular system. In many cases it would be possible to use the scanner as the reader. That is, a photographic image of the label on the artwork can be recognized and read by digital image recognition software, whether alphanumeric or barcodes, etc. Other appropriate readers can be barcode readers, RFID readers, microchip readers, and/or the like.

Image recognition devices can evaluate images of artworks, whether in the digital form or in printed form. In one embodiment, the image recognition device can be the scanner and the image can be evaluated for desired characteristics in essentially real time as the image is being created. The detected characteristics can be immediately associated with the image file. Alternately, the digital images can be reviewed to identify characteristics of interest while the image is in digital form stored as a preexisting file.

### EXAMPLE

The following examples are offered to illustrate, but not to limit the claimed invention.

### Methods and Systems for Compiling and Utilizing Student Artworks.

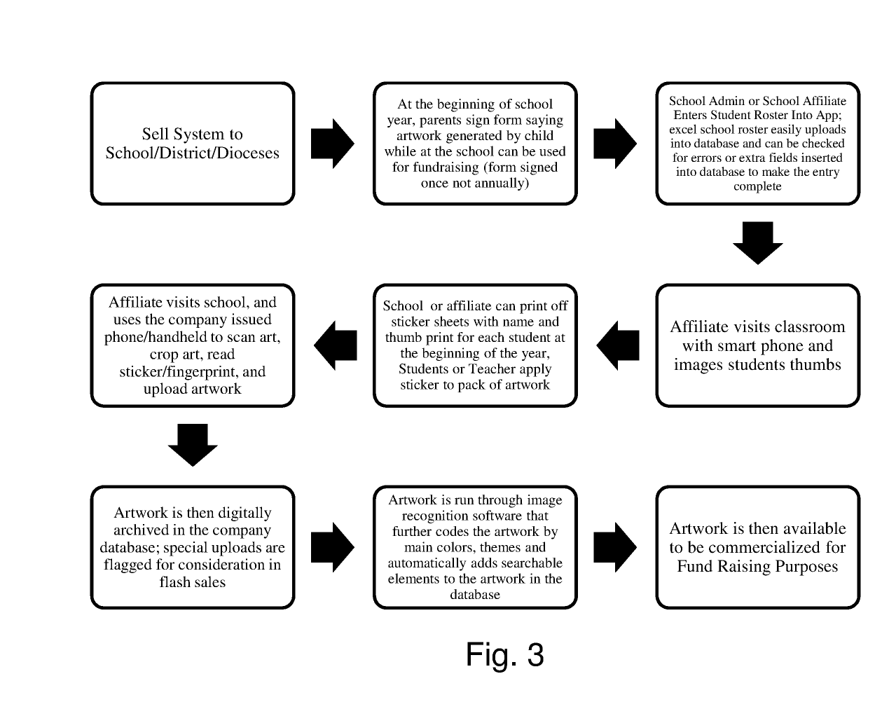

The methods and systems can be used in the academic environment, as described in FIG. 3, combined into a business model. The system can be offered to collages, schools, school districts, or dioceses. The students can be added to a listing of artists so that all their artworks for the school year can be saved in their name Permission forms can be provided to artists and/or their parents desiring to participate in, e.g., creating derivative works of images printed onto products.

Labels would be created by scanning an image of each artist's thumbprint. The image could be printed onto labels to be used in identifying artworks. Alternatively, the artist thumbprint could be made directly onto or into the artwork itself.

Artworks could be immediately scanned on creation, or artworks could be accumulated to process in batch. The scanner can be a smart phone with suitable applications for both artwork image scanning and thumbprint recognition. Multiple images of 3D artworks, such as sculptures, are taken. Images of apparent special value or interest can be earmarked for ready retrieval. Images can be immediately downloaded by bluetooth to a computer hard drive archive with a separate folder for each artist.

Archived images are scanned with recognition software to characterize each image as to characteristics of interest including, subject matter, key colors, date, persons, objects, type of artwork. Identified characteristics are associated with the appropriate image file.

The artworks are available for fundraising at the school. Folders are made available on thumb drives for parents to obtain the full set of artworks created by the student over the course of the school year. Parents have the option of having images of special artworks printed onto desired merchandise, such as calendars. The school in general can have the option to create products imprinted with images of the most interesting or attractive of the school's artworks.

It is understood that the examples and embodiments described herein are for illustrative purposes only and that various modifications or changes in light thereof will be suggested to persons skilled in the art and are to be included within the spirit and purview of this application and scope of the appended claims.

While the foregoing invention has been described in some detail for purposes of clarity and understanding, it will be clear to one skilled in the art from a reading of this disclosure that various changes in form and detail can be made without departing from the true scope of the invention. For example, all the techniques and apparatus described above can be used in various combinations. All publications, patents, patent applications, and/or other documents cited in this application are incorporated by reference in their entirety for all purposes to the same extent as if each individual publication, patent, patent application, and/or other document were individually indicated to be incorporated by reference for all purposes.

What is claimed is:

1. A method of preserving artist artwork histories, the method comprising:
preparing a roster of two or more artists;
preparing unique artist identification labels for each of the artists;
attaching one or more of the identification labels for each artist to one or more artworks created by the respective artist;
digitally scanning an image of the one or more artworks, reading the identification label attached to the artwork, and associating the read artist identification with the digital image of the artist's artwork.

2. The method of claim 1, wherein attaching the labels comprises a technique selected from the group consisting of: applying a label with a pressure sensitive adhesive or tying on a tag.

3. The method of claim 1, wherein the artist identification labels comprise an artist fingerprint.

4. The method of claim 1, wherein the scanning is selected from the group consisting of: digital photography, scanning with a flatbed scanner, 3D imaging, and laser scanning.

5. The method of claim 1, wherein the reading the identification label is selected from the group consisting of: reading a bar code, identifying a fingerprint, character recognition, and RFID detection.

6. The method of claim 1, wherein the association of the artwork image and artist identification comprises inserting the artist identification into metadata of the image.

7. The method of claim 1, wherein the artwork is selected from the group consisting of: a sketch, a painting, a collage, a mosaic, a statue, and jewelry.

8. The method of claim 1, further comprising archiving the artwork scans separately for each artist.

9. The method of claim 1, further comprising associating the digital image with a characteristic of the image, wherein the characteristic is selected from the group consisting of: a color, a date, a person, an animal, a place, and a holiday.

10. The method of claim 9, wherein the characteristic of the image is identified by image recognition software.

11. The method of claim 9, further comprising searching two or more of the images to identify one or more images associated with a characteristic of interest, and presenting one or more of the identified images for viewing.

12. The method of claim 11, further comprising selecting a viewed image and printing the image on to a product selected from the group consisting of: a photo print, a cup, a book, a shirt, a pillow, a calendar, a trophy, and sporting equipment.

13. A system for retaining artist artworks, the system comprising:
a roster of two or more artists;
a set of labels for each of the two or more artists, each set of labels identifying one of the two or more artists;
a scanner adapted to generate a digital image of artworks created by the two or more artists; and,
a reader adapted to read an artist identification label;
wherein artworks created by one of the artists can be labeled with that artist's identification label, scanned with the scanner to generate the digital image, and the label read by a reader to provide an artwork identification for association of the artist identification with the digital image.

14. The system of claim 13, further comprising an image processing subsystem adapted to identify characteristics of interest in images generated by the scanner, wherein the identified characteristics can be searched to determine what images include a characteristic of interest.
